(19) United States
(12) Patent Application Publication
(10) Pub. No.: US 2014/0370825 A1
(43) Pub. Date: Dec. 18, 2014

(54) MULTIBAND ANTENNA APPARATUS

(71) Applicant: JH BASIC HOLDINGS CO., LTD., Suwon-si, Gyeonggi-do (KR)

(72) Inventors: Tae Hwan Kim, Gyeonggi-do (KR); Hyun Young Lee, Gyeonggi-do (KR)

(21) Appl. No.: 14/369,997

(22) PCT Filed: Dec. 28, 2012
(86) PCT No.: PCT/KR2012/011662

§ 371 Date: Jun. 30, 2014

(30) Foreign Application Priority Data
Dec. 29, 2011 (KR) 10-2011-0146030

(51) Int. Cl. H04W 88/06; H04B 1/40

(52) U.S. Cl. CPC H04W 88/06; H04B 1/40
USPC 455/77

(57) ABSTRACT

Disclosed is a multiband antenna apparatus. According to one embodiment of the present invention, a multiband antenna apparatus includes: an antenna radiator connected to each of a feeder pad and a ground pad on a non-ground surface of a mainboard of a wireless communication device and including a first radiator for transmitting and receiving a first frequency band and a second radiator for transmitting and receiving a second frequency band; a frequency adjusting element formed on the non-grounded surface and interconnecting the ground pad and the ground of the mainboard; and a switch unit that is formed on the non-ground surface and electrically disconnects or opens the ground pad and the ground of the mainboard in accordance with an input switching control signal. The resonant frequency of the antenna radiator shifts by the switching operation of the switching unit.

### CROSS-REFERENCE TO RELATED APPLICATION AND CLAIM OF PRIORITY

This patent application is a National Phase application under 35 U.S.C. §371 of International Application No. PCT/KR2012/011662, filed Jul. 4, 2013, which claims priority to Korean Patent Application No. 10-2011-0146030, filed Dec. 29, 2011, entire contents of which are incorporated herein by reference.

### BACKGROUND

1. Field

The present invention relates to a multiband antenna apparatus, and more specifically, to a multiband antenna apparatus capable of adjusting a frequency.

2. Description of the Related Art

Recently, wireless communication apparatuses have been fabricated to perform various functions, such as a Global Positioning System (GPS) function, Digital Multimedia Broadcasting (DMB), an Internet function, authentication, payment, and an MP3 function, in addition to basic wireless communication functions, such as voice call and data communication. Accordingly, when an antenna is installed in a wireless communication apparatus, an existing antenna that transmits and receives signals in a single frequency band is required to be changed into an antenna that transmits and receives signals in multiband frequencies.

Frequencies used in wireless communication are, for example, a bandwidth of 174 to 216 MHz used in terrestrial DMB, a band width of 820 to 960 MHz used in code division multiple access (CDMA) and Global System for Mobile Communications (GSM) 850 and GSM 900, a band width of 1710 to 1990 MHz used in a Korean personal communication system (K-PCS), digital cellular system (DCS) 1800, PCS 1900, and US-PCS, a band width of 2 GHz used in the Universal Mobile Telecommunications System (UTMS), a band width of 2.4 GHz used in a wireless local loop (WLL), a wireless local area network (WLAN), and Bluetooth, and band widths of 1 to 2 GHz and 2 to 4 GHz used in satellite DMB, and the like. Accordingly, the development of a multiband antenna is required in order for a single wireless communication apparatus to transmit and receive signals in various frequency bands.

Generally, when a multi frequency band is implemented using one antenna, the antenna may be designed to transmit and receive signals having great differences in frequency bands, such as a difference between a low frequency band, for example, CDMA, GSM 850, and GSM 900, and a high frequency band, for example, K-PCS, DCS 1800, PCS 1900, and US-PCS.

Meanwhile, wireless communication methods that use adjacent, but different frequency bands, such as GSM 850 and GSM 900, have used separate antennas, since multiband wireless communications are difficult to implement using one antenna apparatus. In this case, there is a problem in that a volume of the antenna apparatus occupying the wireless communication apparatus becomes large since the separate antennas are used for each frequency band. Accordingly, a method of reducing a volume of an antenna apparatus occupying a wireless communication apparatus, while supporting all types of wireless communication methods that use adjacent, but different frequency bands, is needed.

### SUMMARY

Embodiments of the present invention provide a multiband antenna apparatus capable of implementing bandwidth broadening and shifting a resonant frequency.

According to an aspect of the present invention, a multiband antenna apparatus includes an antenna radiator including a first radiator transmitting and receiving a first frequency band and a second radiator transmitting and receiving a second frequency band, wherein each of the first radiator and the second radiator is connected to a feeder pad and a ground pad on a non-grounded surface of a mainboard of a wireless communication apparatus, a frequency adjustment device formed on the non-grounded surface and connecting the ground pad to a ground of the mainboard, and a switching unit formed on the non-grounded surface and configured to electrically short or open the ground pad and the ground of the mainboard according to an input switching control signal. A resonant frequency of the antenna radiator shifts according to a switching operation of the switching unit.

According to exemplary embodiments of the present invention, resonant frequencies of a first radiator and a second radiator may be shifted using a frequency adjustment device and a switching unit. In particular, since the second radiator may shift the resonant frequency in a low frequency band, bandwidth broadening can be implemented in the low frequency band, and all types of wireless communication methods that use adjacent, but different frequency bands, such as GSM 850 and GSM 900, can be supported. In this case, since both of the low frequency band, such as GSM 850 and GSM 900, and the high frequency band, such as PCS, DCS 1800, and WCDMA, are covered using one antenna apparatus, a volume of the antenna apparatus occupying the wireless communication apparatus can be reduced.

### BRIEF DESCRIPTION OF THE DRAWINGS

FIG. 1 is a plan view showing a multiband antenna apparatus in accordance with an embodiment of the present invention.

FIG. 2 is a view showing an antenna of a multiband antenna apparatus in accordance with an embodiment of the present invention.

FIGS. 3A and 3B show a state of a resonant frequency of an antenna radiator being adjusted in a multiband antenna apparatus in accordance with an embodiment of the present invention.

FIG. 4 is a circuit diagram showing a multiband antenna apparatus in accordance with another embodiment of the present invention.

FIG. 5 is a graph showing a voltage standing wave ratio (VSWR) measured when a switch electrically connects a ground pad to a short circuit line in a multiband antenna apparatus in accordance with an embodiment of the present invention.

FIG. 6 is a graph showing a VSWR measured when a switch electrically connects a ground pad to an open circuit line in a multiband antenna apparatus in accordance with an embodiment of the present invention.

### DETAILED DESCRIPTION

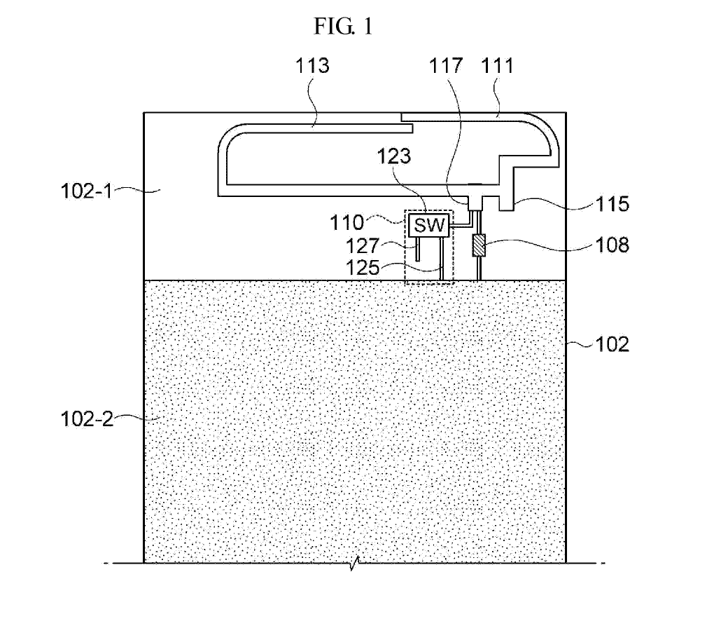

Hereinafter, multiband antenna apparatuses in accordance with exemplary embodiments of the inventive concept will be described with reference to FIGS. 1 to 6. However, the embodiments disclosed herein are merely representative of the present invention, and the scope of the present invention will not be limited by the following embodiments.

In describing the present invention, a detailed description of the known art related to the present invention may be omitted to avoid unnecessarily obscuring the concept of the present invention. In addition, the meanings of specific terms or words used in the specification and claims may be defined by considering functions of the present invention, and may be different in accordance with the intention of a user or an operator and the specific terms' customary usages. Therefore, definitions of the specific terms or words should be based on the contents described throughout the disclosure.

The scope of the invention is to be determined entirely by the following claims, and these embodiments described herein are provided so that this disclosure is thorough and complete, and will fully convey the inventive concept to those skilled in the art.

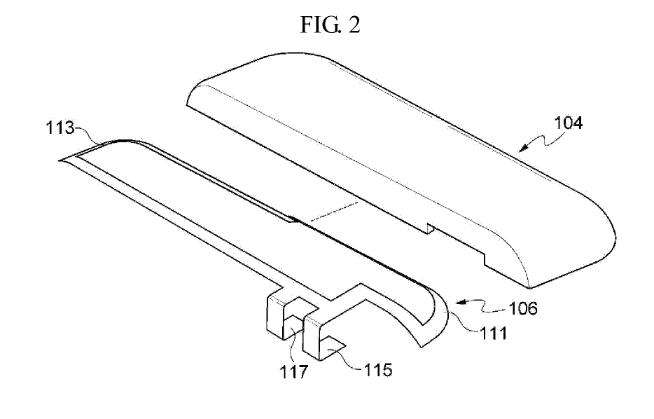

FIG. 1 is a plan view showing a multiband antenna apparatus in accordance with an embodiment of the present invention, and FIG. 2 is a view showing an antenna of a multiband antenna apparatus in accordance with an embodiment of the present invention.

Referring to FIGS. 1 and 2, a multiband antenna apparatus may include a mainboard 102, an antenna carrier 104, an antenna radiator 106, a frequency adjustment device 108, and a switching unit 110. However, the antenna carrier 104, which may be mounted on the mainboard 102, is omitted in FIG. 1 for convenience of illustration.

A non-grounded surface 102-1 may be formed on a portion of the mainboard 102. In addition, a ground 102-2 may be formed on a portion of the mainboard 102 other than the portion on which the non-grounded surface 102-1 is formed. Various circuits and electronic components of a wireless communication apparatus in which the multiband antenna apparatus is embedded are mounted on the ground 102-2.

The antenna carrier 104 may be mounted on the non-grounded surface 102-1 of the mainboard 102. The antenna carrier 104 may separate the antenna radiator 106 from the mainboard 102 by a predetermined distance to improve radiation characteristics of the antenna radiator 106 and reduce a specific absorption rate (SAR) of electromagnetic waves.

The antenna radiator 106 may be formed on a surface of the antenna carrier 104. The antenna radiator 106 may include a first radiator 111 transmitting and receiving a first frequency band and a second radiator 113 transmitting and receiving a second frequency band. Here, the first radiator 111 may receive a signal in a higher frequency band than a signal that the second radiator 113 receives.

The first radiator 111 may transmit and receive, for example, a signal in the range of 1.7 to 2.2 GHz, which is a frequency band of K-PCS, DCS 1800, PCS 1900, US-PCS, and WCDMA, and the second radiator 113 may transmit and receive, for example, a signal in the range of 880 to 960 MHz, which is a frequency band of GSM 900. Here, the first radiator 111 is designed to generate resonance in a high frequency band so as to implement bandwidth broadening. In this case, at least one of the frequency bands of K-PCS, DCS 1800, PCS 1900, US-PCS, and WCDMA may be covered by the first radiator 111.

However, since it is difficult to implement bandwidth broadening with the second radiator 113 because it is designed to generate resonance in a low frequency band, only a frequency band of GSM 900 may be covered by the second radiator 113. Meanwhile, the frequency bands of the first radiator 111 and the second radiator 113 are not limited thereto, and the first radiator 111 and the second radiator 113 may be implemented to transmit and receive signals in various other frequency bands.

The antenna radiator 106 may be connected to a feeder pad 115 and a ground pad 117. Here, one side of the first radiator 111 and the second radiator 113 may be connected to the feeder pad 115, and the other side of the second radiator 113 may be connected to the ground pad 117. The feeder pad 115 may receive power from the mainboard 102 to transfer the power to the first radiator 111 and the second radiator 113.

The antenna radiator 106 may be formed by, for example, a laser direct structuring (LDS) method. In this case, the antenna radiator 106 may be easily formed even on a curved surface of the antenna carrier 104. However, the method of forming the antenna radiator 106 is not limited to the LDS method, and various methods may be used. For example, the antenna radiator 106 may be formed by coating the antenna carrier 104 with conductive ink and performing a plating process, or by coating the antenna carrier 104 with highly conductive ink.

The frequency adjustment device 108 may be formed on the non-grounded surface 102-1 of the mainboard 102. One end of the frequency adjustment device 108 may be connected to the ground pad 117 and the other end of the frequency adjustment device 108 may be connected to the ground 102-2. The frequency adjustment device 108 may include at least one of an inductor and a capacitor. For example, the frequency adjustment device 108 may be formed of the inductor or capacitor, or the inductor and capacitor connected in series or parallel.

The switching unit 110 may include a switch 123, a short circuit line 125, and an open circuit line 127. An end of the switch 123 is connected to the ground pad 117 on the non-grounded surface 102-1. One end of the short circuit line 125 is connected to the switch 123 and the other end of the short circuit line 125 is connected to the ground 102-2. One end of the open circuit line 127 is connected to the switch 123, and the other end of the open circuit line 127 is formed and spaced apart from the ground 102-2 by a predetermined distance.

The switch 123 electrically connects the ground pad 117 to the short circuit line 125 or the open circuit line 127 according to an input switching control signal. That is, the ground pad 117 is electrically connected to the short circuit line 125 or the open circuit line 127 through the switch 123. The switch 123 may be, for example, a single pole double throw (SPDT) switch, but is not limited thereto, and various other switching devices, for example, a field effect transistor (FET), etc., may be used.

Meanwhile, the multiband antenna apparatus further includes a stub (not shown) connected to the ground pad 117 on the non-grounded surface 102-1 of the mainboard 102. The stub (not shown) is formed under the antenna radiator 106 on the non-grounded surface 102-1. In this case, electromagnetic coupling occurs between the stub (not shown) and the antenna radiator 106 formed on the antenna carrier 104 disposed over the stub (not shown), and thereby a frequency bandwidth of the antenna radiator 106 may be widened.

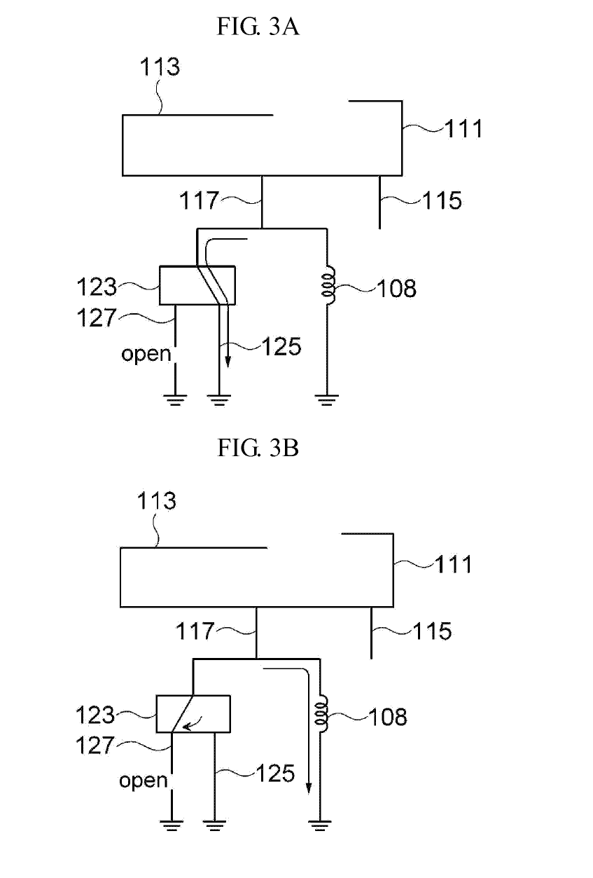

In the multiband antenna apparatus configured as described above, the frequency adjustment device 108 and the switching unit 110 may function to adjust a resonant frequency of an antenna radiator 106. Hereinafter, a case of adjusting the resonant frequency of the antenna radiator 106 will be described with reference to FIGS. 3A and 3B. Here, the frequency adjustment device 108 is assumed to be, for example, an inductor.

Referring to FIG. 3A, when a first switching control signal is input to the switch 123, the switch 123 electrically connects the ground pad 117 to the short circuit line 125 through a switching operation. Then, a current supplied to the antenna radiator 106 through the feeder pad 115 may flow to the ground 102-2 through the switch 123 and the short circuit line 125 since the inductor 108 has a greater amount of impedance than the short circuit line 125.

In this case, the first radiator 111 and the second radiator 113 may generate resonance in frequency bands according to electrical lengths of the first radiator 111 and the second radiator 113. For example, the first radiator 111 may generate resonance in a frequency band of DCS 1800 and WCDMA, and the second radiator 113 may generate resonance in a frequency band of GSM 900.

Referring to FIG. 3B, when a second switching control signal is input to the switch 123, the switch 123 electrically connects the ground pad 117 to the open circuit line 127 through a switching operation. Then, a current supplied to the antenna radiator 106 through the feeder pad 115 may flow from the ground pad 117 to the ground 102-2 through inductor 108 since the open circuit line 127 has a greater amount of impedance than the inductor 108.

In this case, since the inductor 108 is connected to the antenna radiator 106, a resonant frequency shift depending on an inductance value of the inductor 108 may occur. For example, the first radiator 111 may generate resonance in a frequency band of PCS and WCDMA, and the second radiator 113 may generate resonance in a frequency band of GSM 850.

That is, when an electrical connection of the ground pad 117 is changed from the short circuit line 125 to the open circuit line 127 by a switching operation of the switch 123, a resonant frequency shift from the frequency band of DCS 1800 and WCDMA to the frequency band of PCS and WCDMA may occur in the first radiator 111, and a resonant frequency shift from the frequency band of GSM 900 to the frequency band of GSM 850 may occur in the second radiator 113. Here, the degree of resonant frequency shift may be variously adjusted according to an inductance value of the inductor 108.

Likewise, the multiband antenna apparatus in accordance with an embodiment of the present invention may shift the resonant frequencies of the first radiator 111 and the second radiator 113 using the frequency adjustment device 108 and the switching unit 110. In particular, since the second radiator may shift the resonant frequency in a low frequency band, bandwidth broadening may be implemented in the low frequency band, and all types of wireless communication methods that use adjacent, but different frequency bands, such as GSM 850 and GSM 900, may be supported. In this case, since both of the low frequency band, such as GSM 850 and GSM 900, and the high frequency band, such as PCS, DCS 1800, and WCDMA, are covered using one antenna apparatus, a volume of the antenna apparatus occupying the wireless communication apparatus may be reduced.

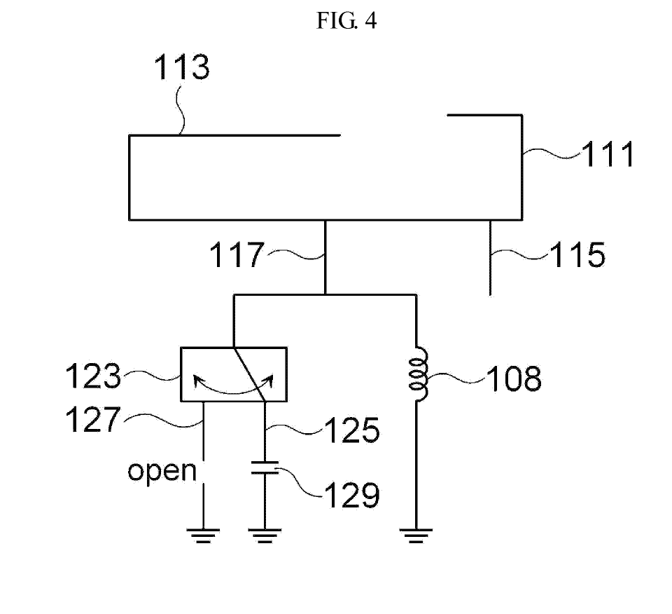

As shown in FIG. 4, a DC blocking capacitor 129 may be formed on the short circuit line 125. When the ground pad 117 is connected to the short circuit line 125 by the switch 123, the DC blocking capacitor 129 may function to block a DC component of a signal received by the antenna radiator 106 and pass an RF component of the signal received by the antenna radiator 106. Here, in order for the DC blocking capacitor 129 to effectively block the DC component in the frequency band of GSM 850 or a higher frequency band, a capacitance value of the DC blocking capacitor 129 may be 30 pF or more. That is, when the capacitance value of the DC blocking capacitor 129 is less than 30 pF, a receiving sensitivity of an antenna may be degraded since the DC component of the signal received by the antenna radiator 106 is not effectively blocked in the frequency band of GSM 850 or more.

In addition, when the DC blocking capacitor 129 is on the short circuit line 125, the inductance value of the inductor 108 may be 4.7 nH or more so that a current supplied to the antenna radiator 106, through the feeder pad 115, flows from the ground pad 117 to the ground 102-2, through the switch 123 and the short circuit line 125, when the switch 123 electrically connects the ground pad 117 to the short circuit line 125 by the first switching control signal.

That is, when the inductance value of the inductor 108 is smaller than 4.7 nH, antenna gains and antenna efficiency may be degraded since the current supplied to the antenna radiator 106, through the feeder pad 115, may flow from the ground pad 117 to the ground 102-2, not only through the switch 123 and the short circuit line 125, but also through the inductor 108 when the switch 123 electrically connects the ground pad 117 to the short circuit line 125 by the first switching control signal.

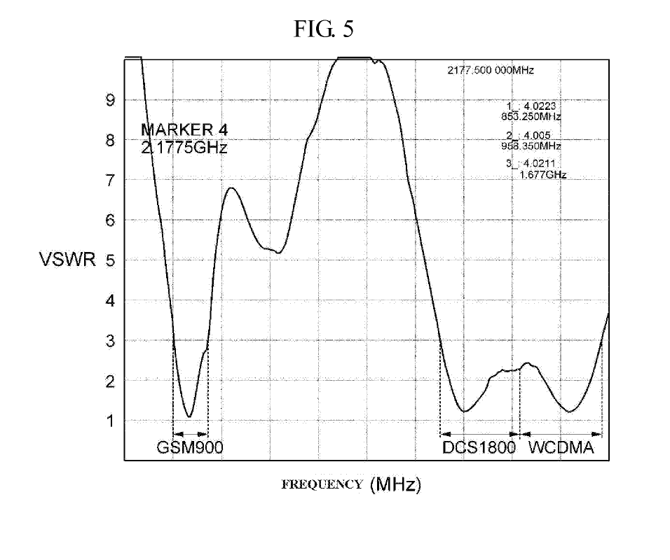

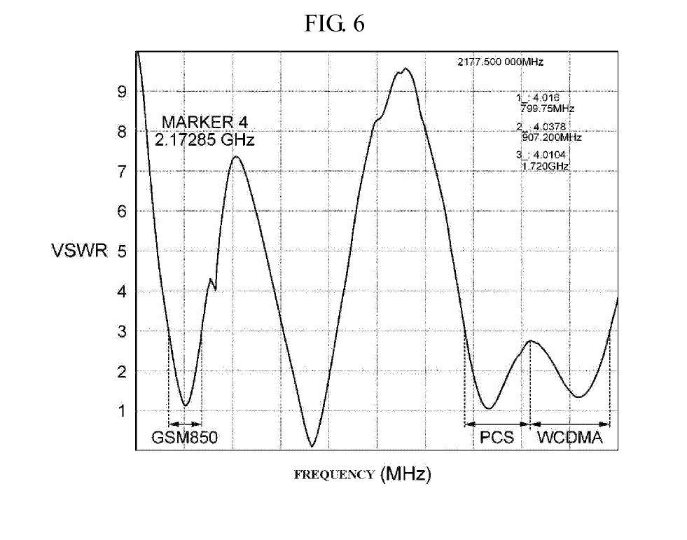

FIG. 5 is a graph showing a voltage standing wave ratio (VSWR) measured when a switch electrically connects a ground pad to a short circuit line in a multiband antenna apparatus in accordance with an embodiment of the present invention, and FIG. 6 is a graph showing a VSWR measured when a switch electrically connects a ground pad to an open circuit line in a multiband antenna apparatus in accordance with an embodiment of the present invention. In FIGS. 5 and 6, when the VSWR is 3 or less, the multiband antenna apparatus may be operated as a normal antenna. Here, the capacitance value of the DC blocking capacitor 129 was 100 pF, and the inductance value of the inductor 108 was 4.7 nH.

Referring to FIG. 5, when the switch 123 electrically connects the ground pad 117 to the short circuit line 125, the first radiator 111 generates resonance in a frequency band of DCS 1800 and WCDMA, and the second radiator 113 generates resonance in a frequency band of GSM 900. Specifically, the first radiator 111 generates resonance in the frequency band of 1.667 GHz to 2.177 GHz, and the second radiator 113 generates resonance in the frequency band of 853 MHz to 958 MHz. The results show resonant frequencies according to electrical lengths of the first radiator 111 and the second radiator 113.

Referring to FIG. 6, when the switch 123 electrically connects the ground pad 117 to the open circuit line 127, the first radiator 111 generates resonance in a frequency band of PCS and WCDMA, and the second radiator 113 generates resonance in a frequency band of GSM 850. Specifically, the first radiator 111 generates resonance in the frequency band of 1.720 GHz to 2.172 GHz, and the second radiator 113 generates a resonance in the frequency band of 800 MHz to 907 MHz. This is because an electrical length of the antenna radiator 106 is changed since the inductor 108 is connected to the antenna radiator 106.

Likewise, when the capacitance value of the DC blocking capacitor 129 is 100 pF and the inductance value of the inductor 108 is 4.7 nH, each of the resonant frequencies of the first radiator 111 and the second radiator 113 shifts by about 50 MHz by a switching operation of the switch 123. In addition, it may be seen that, even when the resonant frequency moves, antenna gains and efficiencies of the first radiator 111 and the second radiator 113 are not degraded and are almost constantly maintained.

While exemplary embodiments of the present invention and aspects thereof have been described herein, it will be apparent to those skilled in the art that various modifications can be made to the above-described exemplary embodiments of the present invention without departing from the spirit or scope of the invention. Thus, it is intended that the present invention covers all such modifications provided they are within the scope of the appended claims and their equivalents.

1. A multiband antenna apparatus, comprising:
an antenna radiator including a first radiator transmitting and receiving a first frequency band and a second radiator transmitting and receiving a second frequency band, wherein each of the first radiator and the second radiator is connected to a feeder pad and a ground pad on a non-grounded surface of a mainboard of a wireless communication apparatus;
a frequency adjustment device formed on the non-grounded surface and connecting the ground pad to a ground of the mainboard; and
a switching unit formed on the non-grounded surface and configured to electrically short or open the ground pad and the ground of the mainboard according to an input switching control signal;
wherein a resonant frequency of the antenna radiator shifts according to a switching operation of the switching unit.

2. The multiband antenna apparatus of claim 1, wherein the switching unit comprises:
a switch connected to the ground pad;
a short circuit line having one end connected to the switch and another end connected to the ground of the mainboard; and
an open circuit line having one end connected to the switch and another end formed to be spaced apart from the ground of the mainboard by a predetermined distance,
wherein the switch electrically connects the ground pad to the short circuit line or the open circuit line according to the switching control signal.

3. The multiband antenna apparatus of claim 2, wherein, when the switch electrically connects the ground pad to the short circuit line, a current supplied to the antenna radiator through the feeder pad flows to the ground through the switch and the short circuit line, and when the switch electrically connects the ground pad to the open circuit line, a current supplied to the antenna radiator through the feeder pad flows to the ground through the frequency adjustment device.

4. The multiband antenna apparatus of claim 2, wherein the switching unit further comprises a DC blocking capacitor formed on the short circuit line.

5. The multiband antenna apparatus of claim 4, wherein the capacitance of the DC blocking capacitor is 30 pF or more.

6. The multiband antenna apparatus of claim 1, wherein the frequency adjustment device is an inductor.

7. The multiband antenna apparatus of claim 6, wherein the inductance of the inductor is 4.7 nH or more.

8. The multiband antenna apparatus of claim 1, further comprising a stub formed to be connected to the ground pad on the non-grounded surface.
